(19) United States
(12) Patent Application Publication
(10) Pub. No.: US 2019/0076913 A1
(43) Pub. Date: Mar. 14, 2019

(54) PISTON PIN AND METHOD FOR MANUFACTURING PISTON PIN

(71) Applicant: HITACHI AUTOMOTIVE SYSTEMS, LTD., Hitachinaka-shi, Ibaraki (JP)

(72) Inventors: Yuto HIGASA, Hadano-shi, Kanagawa (JP); Shin KOIZUMI, Ebina-shi, Kanagawa (JP); Minoru ZENKE, Houfu-shi, Yamaguchi (JP); Takashi IDE, Atsugi-shi, Kanagawa (JP)

(73) Assignee: HITACHI AUTOMOTIVE SYSTEMS, LTD., Hitachinaka-shi, Ibaraki (JP)

(21) Appl. No.: 16/082,528

(22) PCT Filed: Jan. 20, 2017
(86) PCT No.: PCT/JP2017/001906

§ 371 Date: Sep. 5, 2018

(30) Foreign Application Priority Data
Mar. 8, 2016 (JP) 2016-043981

(51) Int. Cl. B21K 1/18; F16J 1/16

(52) U.S. Cl. CPC B21K 1/18; F02F 3/00; F16J 1/16

(57) ABSTRACT

Pin body has lightening hole having one-end-side and another-end-side large diameter parts formed on both end sides in the longitudinal direction; a central small diameter part; one-end-side and another-end-side first rounded parts each being provided between the large diameter part and the central small diameter part, having an inner diameter decreasing from each large diameter part side toward the central small part side, and having a rate of change of the inner diameter increasing from each large diameter part side toward the central small diameter part side; and one-end-side and another-end-side second rounded parts each being provided between each first rounded part and the central small diameter part, having an inner diameter decreasing from each first rounded part toward the central small diameter part side, and having a rate of change of the inner diameter decreasing from each first rounded part toward the central small diameter part side.

### TECHNICAL FIELD

The present invention relates to a piston pin, which is applied, for example, to an automotive internal combustion engine and connects a piston of the internal combustion engine and a connecting rod, and a method for manufacturing a piston pin.

### BACKGROUND ART

As a conventional piston pin, one described in the following Patent Publication 1 is known. This piston pin has a pin body made of a metal material and a lightening hole formed along the longitudinal direction of the pin body, and is formed in a generally cylindrical shape as a whole.

It is desirable that the pin body is formed to have a thin thickness (light weight) from the viewpoint of improving fuel economy of an internal combustion engine by reducing inertial force accompanied by reciprocal movement of the internal combustion engine, but it is necessary in a central predetermined range in the longitudinal direction that undergoes a relatively large shear force or compressive force from piston or crankshaft during the engine operation to have a predetermined thickness that is capable of resisting these external forces.

Thus, for satisfying these demands, the lightening hole is formed to have a central small diameter part having an evenly small inner diameter in a central predetermined range in the longitudinal direction of the pin body and to have one-end-side rounded part and another-end-side rounded part where diameters of both end portions of the pin body in the longitudinal direction increase from the side of the central small diameter part toward their respective opening end sides.

Each of the one-end-side and another-end-side rounded parts has a simple round shape (horn shape) where rate of change of its inner diameter increases gradually from the central small diameter part toward its opening end side. In this manner, both end portions of the pin body in the longitudinal direction that do not undergo large external forces are reduced in thickness, thereby reducing the pin body in weight while retaining its durability.

### PRIOR ART PUBLICATIONS

### Patent Publications

Patent Publication 1: Japanese Patent Application Publication 2001-182830

### SUMMARY OF THE INVENTION

### Task to be Solved by the Invention

As mentioned above, the conventional piston pin is, however, formed such that each rounded part of the lightening hole has a simple rounded shape where rate of change of its inner diameter increases gradually from the side of the central small diameter part toward its opening end side. Therefore, it was not possible to secure a sufficient weight reduction at a location of each rounded part close to the central small diameter part. With this, the weight reduction of the pin body was insufficient.

In view of such technical task, the present invention was made, and its object is to provide a piston pin that can be planned to further reduce its weight while retaining durability and a method for manufacturing the piston pin.

### Means for Solving the Task

In particular, the present invention is characterized in that the pin body is formed with a lightening hole having one-end-side and another-end-side large diameter parts that are formed on both end sides in the longitudinal direction of the pin body, a central small diameter part that is provided between both large diameter parts, one-end-side and another-end-side first rounded parts each of which is provided between the in large diameter part and the central small diameter part, each of which has an inner diameter that decreases from the side of the large diameter part toward the side of the central small part and each of which has a rate of change of the inner diameter that increases from the side of the large diameter part toward the side of the central small diameter part, and one-end-side and another-end-side second rounded parts each of which is provided between the first rounded part and the central small diameter part, each of which has an inner diameter that decreases from the first rounded part toward the side of the central small diameter part and each of which has a rate of change of the inner diameter that decreases from the side of the first rounded part toward the side of the central small diameter part.

### Advantageous Effect of the Invention

According to the present invention, it is possible to achieve an effective weight reduction without damaging durability.

### BRIEF DESCRIPTION OF THE DRAWINGS

FIG. 1 is a perspective view showing a connection condition between a piston and a connecting rod by a piston pin according to the present embodiment, while a part of the piston is shown in cross-section;

FIG. 2 is a sectional view showing a connection condition between the piston and the connection rod by the piston pin;

FIG. 3 is a longitudinal section of the piston pin;

FIG. 4 is a view showing the shapes of one-end-side first and second rounded parts, which are provided at the piston pin, by respective circles of curvature;

FIG. 5 is an enlarged view of a portion indicated by an index line A of FIG. 2;

FIG. 6 is a sectional view of a forging apparatus showing the first step in the the piston pin production process;

FIG. 7 is a sectional view of the forging apparatus showing the second step in the piston pin production process;

FIG. 8 is a sectional view of the forging apparatus showing the third step in the piston pin production process;

FIG. 9 is a sectional view of the forging apparatus showing the fourth step in the piston pin production process;

FIG. 10 is a sectional view of the forging apparatus showing the fifth step in the piston pin production process; and

FIG. 11 is a sectional view showing fiber flows of a metal material constituting the piston pin.

### MODE FOR IMPLEMENTING THE INVENTION

In the following, an embodiment of the piston pin according to the present invention is described in detail with reference to the drawings.

[Piston Pin Construction]

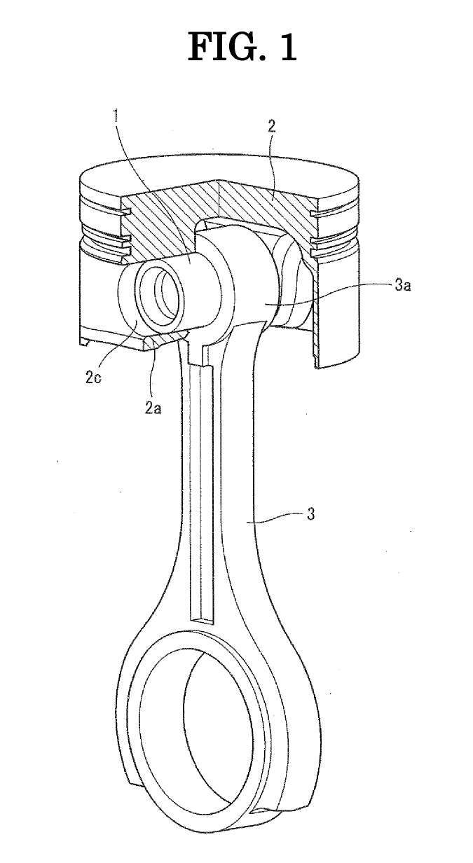

As shown in FIG. 1 to FIG. 3, a piston pin 1 according to the present embodiment is equipped with a pin body 10, which is formed in a generally cylindrical shape by a metal material such as steel material, and a lightening hole, which is formed on the inner peripheral side of the pin body 1 along the longitudinal direction. As shown in rig. 2 in particular, it is arranged across and inserted into first and second pin holes 2c, 2d drilled through first and second pin boss parts of a piston 2 of an internal combustion engine and an insertion hole 3b drilled through a small end 3a of a connecting rod 3, thereby connecting the piston 2 and the connecting rod 3.

The pin body 10 is shaped by the after-mentioned special forging method. It is formed such that its outer shape in a section perpendicular to the longitudinal direction becomes a circular shape, and its outer diameter is formed to be slightly smaller than the inner diameter of the pin holes 2c, 2d of the piston 2 and the insertion hole 3b of the connecting rod 3.

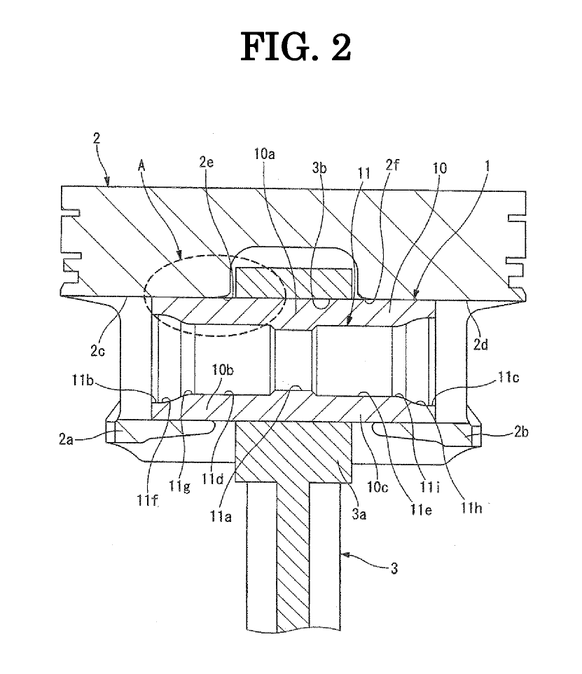

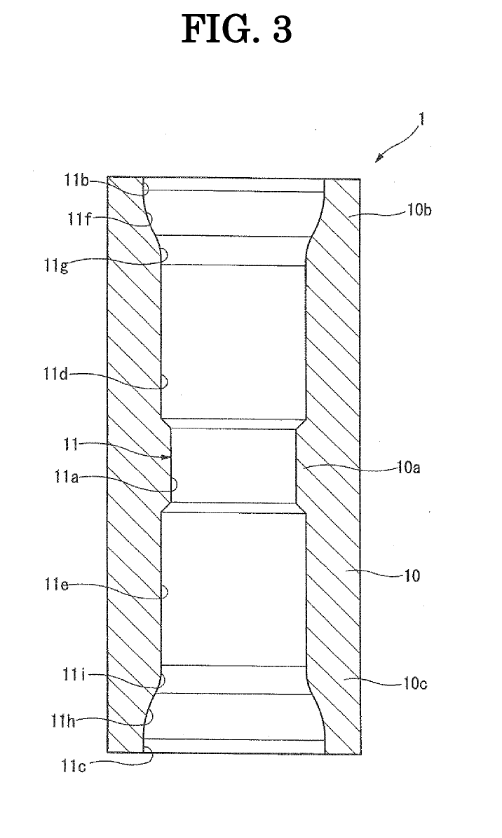

As shown in FIG. 2 and FIG. 3, the lightening hole 11 is mainly constituted of a small diameter part 11a provided at a central part 10a in the longitudinal direction of the pin body 10, one-end-side large diameter part 11b provided on one end side 10b in the longitudinal direction of the pin body 10, another-end-side large diameter part 11c provided on another end side 10c in the longitudinal direction of the pin body 10, one-end-side medium diameter part 11d provided between the small diameter part 11a and the one-end-side large diameter part 11b, and another-end-side medium diameter part 11e provided between the small diameter part 11a and the another-end-side large diameter part 11c. In the present embodiment, the small diameter part 11a, the one-end-side medium diameter part 11d, and the another-end-side medium diameter part 11e constitute a central small diameter part according to the present invention.

The one-end-side large diameter part 11b extends in a predetermined range of the pin body 10 that is received in the first pin hole 2c under a connection between the piston 2 and the connecting rod 3, that is, in a predetermined range from an edge of the one-end-side 10b of the pin body 10 toward the side of the central part 10a.

On the other hand, the another-end-side large diameter part 11c extends in a predetermined range of the pin body 10 that is received in the second pin hole 2d under a connection between the piston 2 and the connecting rod 3, that is in a predetermined range from an edge of the another-end-side 10c of the pin body 10 toward the side of the central part 10a.

Furthermore, the one-end-side large diameter part 11b and the another-end-side large diameter part 11c are formed to have inner diameters that are almost the same, and their inner peripheral surfaces in the case of the longitudinal sectional view of the pin body 10 are formed to be respectively almost parallel with the longitudinal direction of the pin body 10.

The small diameter part 11a and the one-end-side and another-end-side medium diameter parts 11d, 11e are formed to extend in a predetermined range containing a region that is received in the insertion hole 3b of the connecting rod 3 under a connection between the piston 2 and the connecting rod 3.

Herein, the inner diameters of the small diameter part 11a and each medium diameter part 11d, 11e and the inner diameter of each large diameter part 11b, 11c are set up, based on the degree of external force such as shear force, compressive force, etc. acting on each region of the pin body 10 during operation of the internal combustion engine.

As it is specifically explained, a section formed with the small diameter part 11a and each medium diameter part 11d, 11e of the pin body 10 undertakes large external forces from the piston 2 and/or the connecting rod 3 during operation of the internal combustion engine. Therefore, it is required to have a thickness that is capable of resisting these external forces. Thus, the inner diameter of each medium diameter part 11d, 11e is set to a predetermined small diameter such that a region formed with each medium diameter part 11d, 11e of the pin body 10 satisfies the thickness.

On the other hand, as mentioned above, a region formed with each large diameter part 11b, 11c of the pin body 10 is received in each pin bole 2c, 2d. Therefore, it does not undertake a large force from the piston 2 and/or the connecting rod 3 during operation of the internal combustion engine, and it is not necessary to have a large thickness. Thus, inner diameters of both large diameter parts 11b, 11c are set to predetermined large diameters to have a thickness at which there occurs no deformation and/or damage in a region formed with both large diameter parts 11b, 11c of the pin body 10 when starting the engine.

Furthermore, the lightening hole 11 is formed with one-end-side first and second rounded parts 11f, 11g between the one-end-side large diameter part 11b and the one-end-side medium diameter part 11d, and another-end-side first and second rounded parts 11h, 11i between the another-end-side large diameter part 11c and the another-end-side medium diameter part 11e.

In the following, since the one-end-side first and second rounded parts 11f, 11g and the another-end-side first and second rounded parts 11h, 11i are symmetrical in shape with respect to the central part 10a of the pin body 10, as a matter of convenience, only the one-end-side first and second rounded parts 11f, 11g are explained in detail, and the explanation of the another-end-side first and second rounded parts 11h, 11i is omitted.

As shown in FIG. 2 and FIG. 3, the one-end-side first rounded part 11f is connected at its edge on the one end side 10b with an edge on the another end side 10c of the one-end-side large diameter part 11b.

Furthermore, this one-end-side first rounded part 11f is formed such that the inner diameter decreases from the side of the one-end-side large diameter part 11b toward the one-end-side medium diameter part 11d and that rate of change of the inner diameter increases from the side of the one-end-side large diameter part 11b toward the side of the one-end-side medium diameter part 11d.

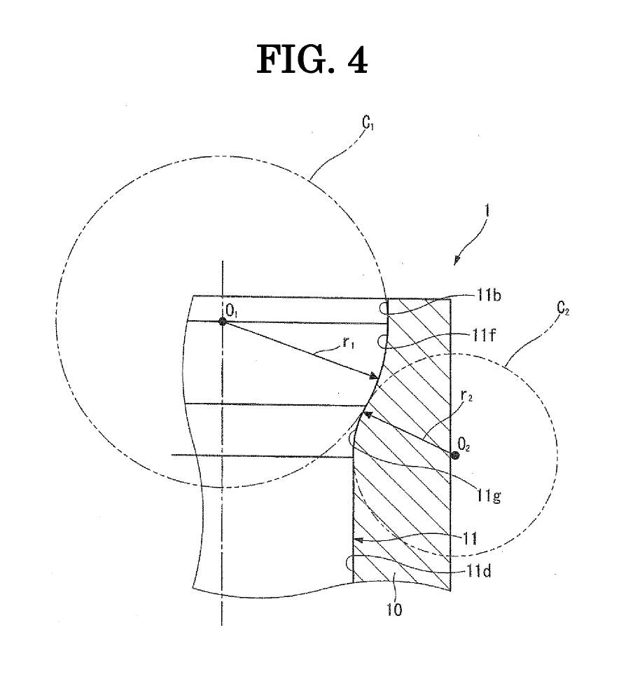

Furthermore, in case that a curved shape of the one-end-side first rounded part 11f is represented by a circle of curvature C₁ shown in FIG. 4, the one-end-side first rounded part 11f is formed such that a center of curvature O₁ of the circle of curvature C₁ is positioned away from the edge of the one end side 10b of the pin body 10 toward the another end side 10c.

As shown in FIG. 2 and FIG. 3, the one-end-side second rounded part 11g is connected at its edge on the one end side 10b with the edge on the another end side 10c of the one-end-side first rounded part 11f and is connected at its edge on the another end side 10c with the edge on the one end side 10b of the one-end-side medium diameter part 11d. With this, a transitional part between the one-end-side large diameter part 11b and the one-end-side medium diameter part 11d has a structure connected by a series of continuous curved surfaces formed of the one-end-side first and second rounded parts 11f, 11g.

Furthermore, this one-end-side second rounded part 11g is formed such that the inner diameter decreases from the side of the one-end-side first rounded part 11f toward the side of the one-end-side medium diameter part 11d and that the rate of change of the inner diameter decreases from the side of the one-end-side first rounded part 11f toward the side of the one-end-side medium diameter part 11d.

Furthermore, in case that a curved shape of the one-end-side second rounded part 11g is represented by a circle of curvature C₂ shown in FIG. 4, the one-end-side second rounded part 11g is formed such that a radius of curvature r₂ of the circle of curvature C₂ is made smaller than a radius of curvature r₁ of the one-end-side first rounded part 11f.

Inner end parts, which are opposed to each other, of the first pin hole 2c and the second pin hole 2d are respectively formed with one-end-side and another-end-side roller burnished parts 2e, 2f as clearance parts of the pin body 10 when the pin body 10 is deformed by action of a large external force.

In the following, since the one-end-side roller burnished part 2e and the another-end-side roller burnished part 2f are symmetrical in shape with respect to the central part 10a of the pin body 10, as a matter of convenience, only the one-end-side roller burnished part 2e is explained in detail, and the explanation of the another-end-side roller burnished part 2f is omitted.

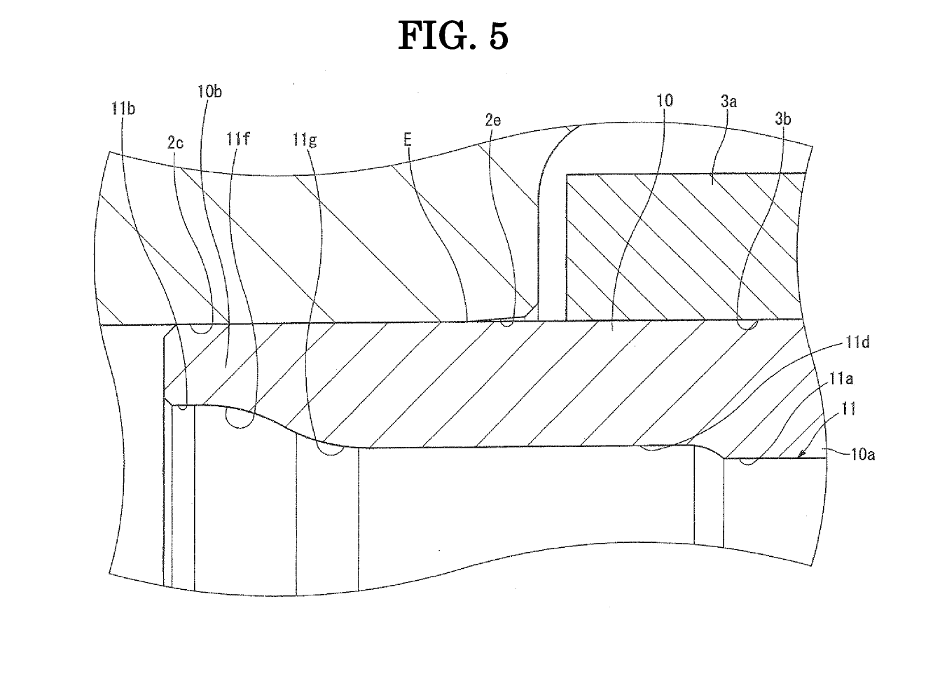

The one-end-side roller burnished part 2e is shaped by conducting a roller burnishing treatment (plastic deformation treatment) on the inner peripheral surface of the first pin hole 2c by a burnishing roller or the like not shown in the drawings. As shown in FIG. 5, it is formed in a tapered shape to make a gradual diameter expansion from the one end side 10b of the pin body 10 toward the central part 10a. With this, the one-end-side roller burnished part 2e functions as a deformation clearance part of the pin body 10 and serves to improve strength of the first pin boss part 2a based on the roller burnishing treatment.

Furthermore, the one-end-side roller burnished part 2e is formed such that its whole region is positioned on the another end side 10c of the pin body 10 relative to the whole region of the one-end-side second rounded part 11g.

[Piston Pin Production Method]

The piston pin 1 is shaped by conducting cold forging on a cylindrical metallic workpiece 10A by a forging apparatus 20.

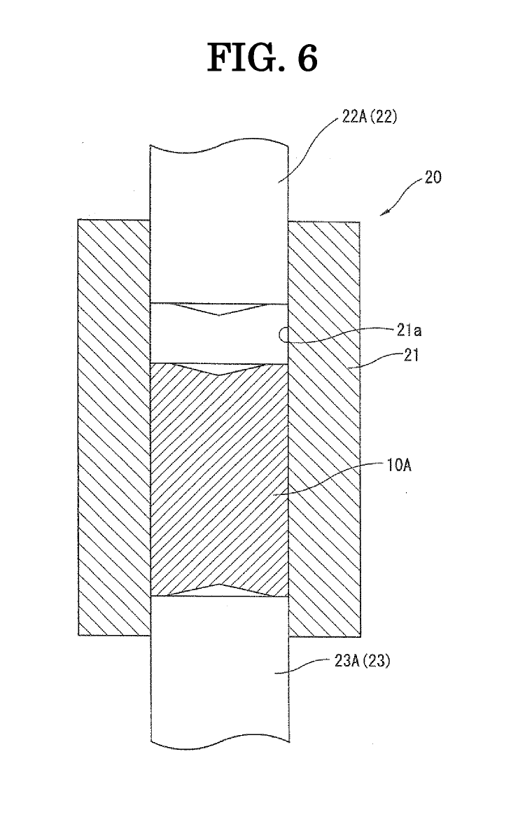

Firstly, major constituents of the forging apparatus 20 are explained. As shown in FIG. 6 etc., this forging apparatus 20 is equipped with a die 21 as a fixed die with a holding hole 21a that passes therethrough, holds the metallic workpiece 10A therein and is generally circular section; a punch pin 22 that is provided to be insertable into the holding hole 21a of the die 21 from one end side; a die pin 23 that is similarly provided to be insertable into the holding hole 21a from another end side; and a pressing mechanism not shown in the drawings for raising or lowering and pressing the punch pin 22. The metallic workpiece 10A held in the holding hole 21a of the die 21 is subjected to pressing by using the punch pin 22 and the die pin 23 with various shapes in accordance with the shaping steps, thereby obtaining the desired shape of the piston pin 1.

Next, the forging operation of the piston pin 1 by the forging apparatus 20 is explained for each step with reference to FIG. 6 to FIG. 10.

Firstly, as the first step, as shown in FIG. 6, the metallic workpiece 10A is inserted into and arranged in the holding hole 21a of the die 21. A tip end part of an end surface reforming punch pin 22A is pressed against one end surface on one end side in the longitudinal direction of the metallic workpiece 10A, and a tip end part of a die pin 23A is pressed against another end surface on another end side in the longitudinal direction of the metallic workpiece 10A, thereby making plastic deformation of both end surfaces of the metallic workpiece 10A and reforming both end surfaces.

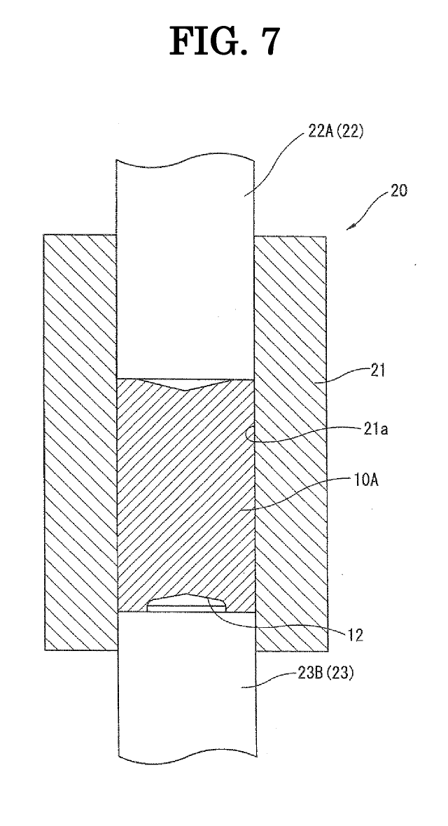

Next, as the second step, as shown in FIG. 7, the end surface reforming die pin 23A is replaced with a guide hole forming die pin 23B. Then, a tip end part of the die pin 23B is pressed against the another end surface of the metallic workpiece 10A to achieve plastic deformation, thereby forming on the another end surface a guide hole 12 as a lower hole for guiding the after-mentioned pin hole forming die pin 23C into the inside of the metallic workpiece 10A.

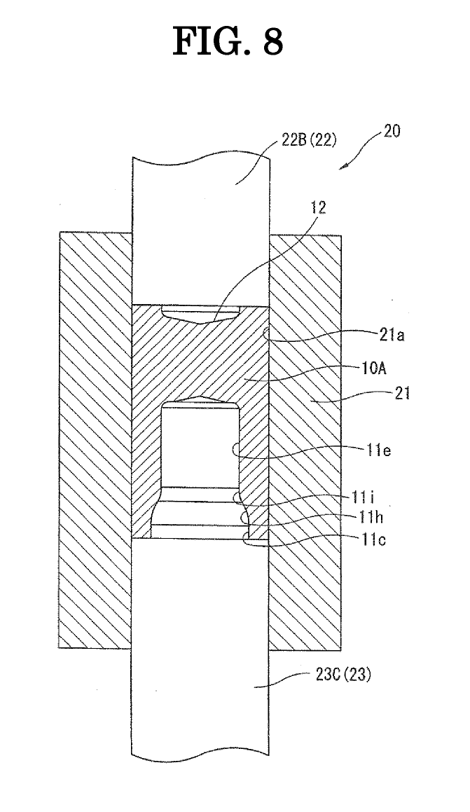

Then, as the third step, as shown in FIG. 8, the end surface reforming punch pin 22A is replaced with a guide hole forming punch pin 22B. Then, the punch pin 22B is lowered, and a tip end part of the punch pin 22B is pressed against one end surface of the metallic workpiece 10A to achieve plastic deformation, thereby forming on the one end surface a guide hole 12 as a lower hole for guiding the punch pin 22 into the inside of the metallic workpiece 10A.

Furthermore, at this time, when making the replacement of the punch pin 22B, the guide hole forming die pin 23B is also replaced with a lightening hole forming die pin 23C which is a die conforming to the shape of the lightening hole 11. With this, at the above-mentioned downward movement of the punch pin 22B, the die pin 23C is pressed into the inside of the metallic workpiece 10A, while it is guided into the guide hole 12 on the another end side of the metallic workpiece 10A. As a result, the another end side of the inside of the metallic workpiece 10A is subjected to a large plastic deformation.

That is, while the lightening hole forming die pin 23C is pressed thereinto, the metallic workpiece 10A flows downwardly (in the same direction as the pressing direction of the punch pin 22B) in FIG. 8 and extends in the longitudinal direction along the outer peripheral surface of the die pin 23C, thereby forming on the another end side the another-end-side large diameter part 11c, the another-end-side first rounded part 11h, the another-end-side second rounded part 11i, and the another-end-side medium diameter part 11e.

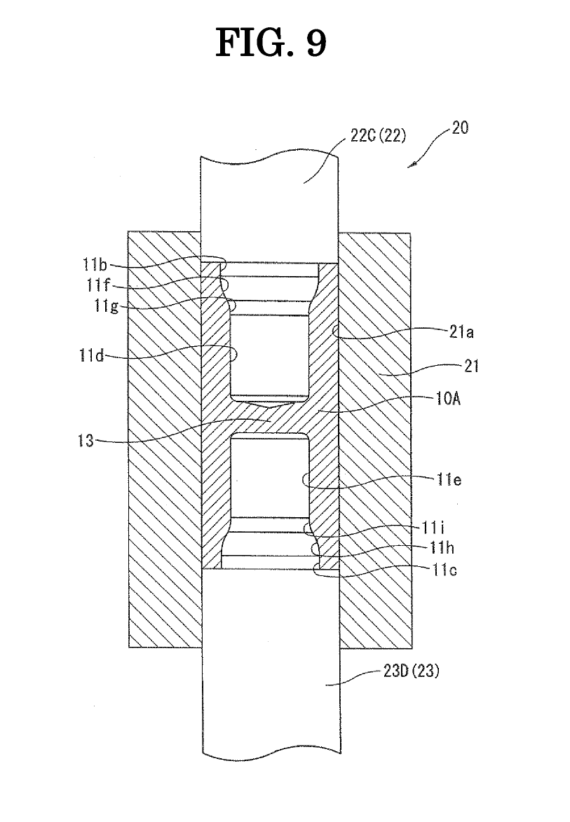

In the subsequent fourth step, as shown in FIG. 9, the one end side of the inside of the metallic workpiece 10A is subjected to plastic deformation by the punch pin 22.

That is, while a lightening hole forming punch pin 22C as a die conforming to the shape of the lightening hole 11 and as a replacement for the guide hole forming punch pin 22B is pressed thereinto, the metallic workpiece 10A extends in the longitudinal direction along the outer peripheral surface of the punch pin 22C, thereby forming the one-end-side large diameter part 11b, the one-end-side first rounded part 11f, the one-end-side second rounded part 11g, and the one-end-side medium diameter part 11d.

At this time, a die pin (mandrel) 23D that functions as a core and a replacement for the lightening hole forming die pin 23C is inserted on the another end side of the inside of the metallic workpiece. This die pin 23D prevents the metallic workpiece 10A from having plastic deformation on the another end side of its inside which is caused by pressing the punch pin 22C thereinto.

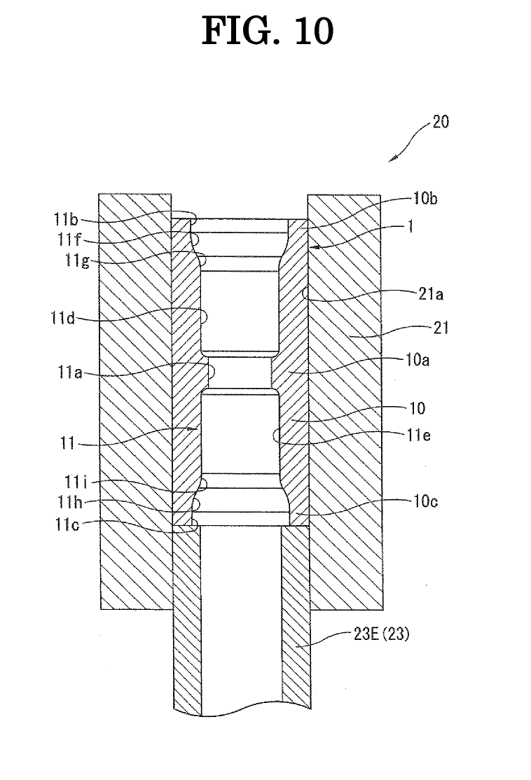

At last, as the fifth step, as shown in FIG. 10, the die pin 23D is replaced with a positioning die pin 23E that is generally cylindrical, and a partition wall part 13 remaining at a central part in the longitudinal direction is punched by a piercing tool not shown in the drawings. After that, the finished piston pin 1 is taken out of the holding hole 21a of the die 21, thereby completing a series of forging operations of the piston pin 1.

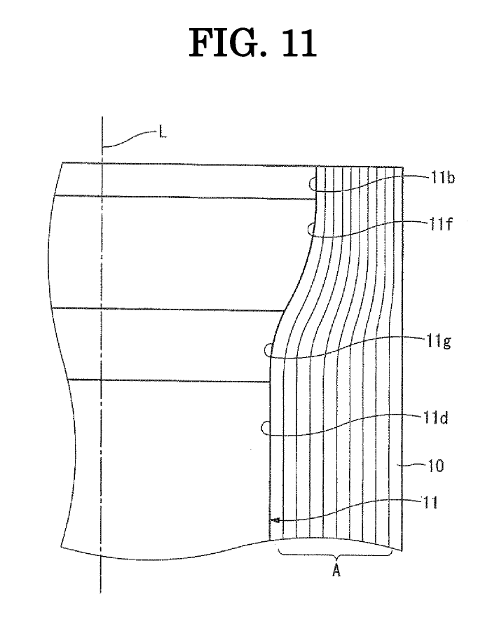

Herein, it is generally known that fiber flow as a flow of metal fiber during the extension movement upon shaping is formed in the inside of the metal material shaped by the forging. A fiber flow A as show in FIG. 11 is also formed in the present embodiment's piston pin 1 (pin body 10) shaped based on the above-mentioned operation steps.

In the following, the fiber flow A is explained. Since its orientation is symmetrical in shape with respect to the central part 10a of the pin body 10, as a matter of convenience, it is explained based on the one end side 10b.

Furthermore, when showing orientation of the fiber flow A, the explanation is conducted by defining an imaginary line that passes through the center of outer shape of the pin body 10 and extends in the longitudinal direction of the pin body 10 as a center axis L of the pin body 10.

That is, the fiber flow A is formed when the metallic workpiece 10A flows in the longitudinal direction along the outer peripheral surface of the lightening hole forming punch pin 22C and die pin 23C in the above-mentioned third and fourth steps. It is oriented along the longitudinal direction of the pin body 10 in regions where the one-end-side large diameter part 11b and the one-end-side medium diameter part 11d of the pin body 10 are formed.

Furthermore, the fiber flow A in a region where the one-end-side first rounded part 11f of the pin body 10 is formed changes from a direction along the longitudinal direction of the pin body 10 to a direction that becomes closer to the center axis L of the pin body 10, from the side of the one-end-side large diameter part 11b toward the one-end-side second rounded part 11g.

Furthermore, the fiber flow A in a region where the one-end-side second rounded part 11g of the pin body 10 is formed changes from a direction that becomes closer to the center axis L of the pin body 10 to a direction that is along the longitudinal direction of the pin body 10, from the side of the one-end-side first rounded part 11f toward the one-end-side medium diameter part 11d.

### Advantageous Effect of the Present Embodiment

In the following, since the advantageous effect by the present embodiment is similarly obtained on both of the one end side 10b and the another end side 10c of the piston pin 1 (pin body 10), as a matter of convenience, the explanation is conducted based on the one end side 10b.

Therefore, according to the piston pin 1 of the present embodiment, the lightening hole 11 is formed in the pin body 10 for reducing weight. On the other hand, the inner diameter of the lightening hole 11 in a predetermined range at a middle position in the longitudinal direction of the pin body 10, that is, in a range where a relatively large force acts from the piston 2 and/or the connecting rod 3 during the engine operation, is formed to have a relatively small diameter as the one-end-side medium diameter part 11d. Therefore, it is possible to achieve the weight reduction without damaging durability.

Furthermore, in the present embodiment, the diameter is increased from the one-end-side medium diameter part 11d toward the direction of the end part by a short span via the one-end-side first and second rounded parts 11f, 11g, and a part on the open end side is formed to have a relatively larger diameter as the one-end-side large diameter part 11b than the one-end-side first rounded part 11f. Therefore, it is possible to more efficiently achieve weight reduction of the pin body 10.

In particular, in the present embodiment, the one-end-side large diameter part 11b is formed such that its inner peripheral surface in the case of the longitudinal sectional view of the pin body 10 becomes almost parallel with the longitudinal direction of the pin body 10. Therefore, the thickness of the pin body 10 in a region where the one-end-side large diameter part 11b of the pin body 10 is formed becomes the minimum in total. Therefore, it is possible to achieve a further weight reduction of the pin body 10.

Furthermore, in the present embodiment, a transitional part between the one-end-side medium diameter part 11d and the one-end-side large diameter part 11b is connected by a continuous curved surface formed of the one-end-side first and second rounded parts 11f, 11g. Therefore, as compared with one having the transitional part formed with steps or the like having edges (corners), it is possible to relieve stress concentration when an external force acts from the piston 2 and/or the connecting rod 3 during the engine operation. As a result, it is possible to prevent the occurrence of an unintentional deformation of the piston pin 1.

By the way, as mentioned above, fiber flow is formed in the inside of the metallic material shaped by forging. This fiber flow has a characteristic to improve toughness of the metallic material in case that an external force acts along the fiber flow.

Thus, in the present embodiment to activate this characteristic, the piston pin 1 is shaped by the above-mentioned forging steps. With this, the fiber flow A in the inside of the pin body 10 in a region where the one-end-side first and second rounded parts 11f, 11g are formed is stood (oriented) in a direction closer to the center axis L of the pin body 10.

With this, the orientation of the fiber flow A in the inside of the pin body 10 in a region where the one-end-side first and second rounded parts 11f, 11g are formed becomes closer to the direction of action of an external force acting on the piston 2 and/or the connecting rod 3 during the engine operation. Therefore, it is possible to improve toughness against the external force, thereby improving strength of the piston 1.

Furthermore, in the present embodiment, the one-end-side first rounded part 11f is formed such that its radius of curvature r₁ becomes larger than the radius of curvature r₂ of the one-end-side second rounded part 11g. Therefore, the thickness change from a region where the one-end-side second rounded part 11g of the pin body 10 is formed to a region where the one-end-side large diameter part 11b is formed becomes gentle. With this, the thickness at an end part of the one end side 10b of the pin body 10 is secured without becoming extremely thin, thereby preventing defects such as breaking.

Furthermore, the radius of curvature r₂ of the one-end-side second rounded part 11g is made small. With this, the orientation of the fiber flow A is further raised up. Therefore, it also becomes possible to improve strength of the piston pin 1.

Furthermore, in the present embodiment, the one-end-side first rounded part 11f is formed such that the center of curvature O₁ of the circle of curvature C₁ is positioned to be away from the edge of the one end side 10b of the pin body 10 toward the another end side 10c. Therefore, it is possible to sufficiently secure width in the longitudinal direction of the one-end-side large diameter part 11b and achieve weight reduction of the piston pin 1.

Furthermore, as compared with a case in which the one-end-side first rounded part 11f is arranged and formed such that the center of curvature O₁ is positioned on the edge of the one end side 10b of the pin body 10, the radius of curvature r₁ becomes necessarily small. Therefore, the orientation of the fiber flow A is raised up. This makes it possible to further improve strength of the piston pin 1.

Furthermore, in the present embodiment, the one-end-side second rounded part 11g is such that its whole region is positioned on the one end side 10b of the pin body 10 relative to the whole region of the one-end-side roller burnished part 2e. With this, a corner part E (see FIG. 5) that has been slightly formed between the first pin hole 2c and the one-end-side roller burnished part 2e is prevented from abutting against a location with a relatively low strength, such as the one-end-side large diameter part 11b or the one-end-side first and second rounded parts 11f, 11g. Therefore, it is possible to prevent defects such as the occurrence of deformation or the like resulting from the occurrence of intense stress concentration.

The present invention is not limited to the constitution of the embodiment, but it is also possible to suitably change the constitution as long as it does not deviate from the point of the invention.

For example, in the present embodiment, it was explained that the pin body 10 (piston pin 1) is shaped by forging, but this may be shaped by machining such as turning (cutting) treatment.

As a piston pin and a method for manufacturing the piston pin based on the above-explained embodiment, for example, those mentioned in the following can be conceivable.

The piston pin in its one mode is equipped with a pin body made of a metallic material and a lightening hole formed in a longitudinal direction of the pin body and connects a piston and a connecting rod of an internal combustion engine. The lightening hole comprises one-end-side large diameter part provided at one end side in the longitudinal direction of the pin body; another-end-side large diameter part provided at another end side in the longitudinal direction of the pin body; a central small diameter part that is provided between the one-end-side large diameter part and the another-end-side large diameter part, the central small diameter part having an inner diameter smaller than those of the one-end-side large diameter part and the another-end-side large diameter part; one-end-side first rounded part that is provided between the one-end-side large diameter part and the central small diameter part, the one-end-side first rounded part having an inner diameter that decreases from a side of the one-end-side large diameter part toward a side of the central small diameter part, the one-end-side first rounded part having a rate of change of the inner diameter that increases from the side of the one-end-side large diameter part toward the side of the central small diameter part; one-end-side second rounded part that is provided between the one-end-side first rounded part and the central small diameter part, the one-end-side second rounded part having an inner diameter that decreases from the one-end-side first rounded part toward the side of the central small diameter part, the one-end-side second rounded part having a rate of change of the inner diameter that decreases from the side of the one-end-side first rounded part toward the side of the central small diameter part; another-end-side first rounded part that is provided between the another-end-side large diameter part and the central small diameter part, the another-end-side first rounded part having an inner diameter that decreases from a side of the another-end-side large diameter part toward the side of the central small diameter part, the another-end-side first rounded part having a rate of change of the inner diameter that increases from the side of the another-end-side large diameter part toward the side of the central small diameter part; and another-end-side second rounded part that is provided between the another-end-side first rounded part and the central small diameter part, the another-end-side second rounded part having an inner diameter that decreases from the another-end-side first rounded part toward the side of the central small diameter part, the another-end-side second rounded part having a rate of change of the inner diameter that decreases from the side of the another-end-side first rounded part toward the side of the central small diameter part.

In a preferred mode of the piston pin, the pin body is shaped by forging and is formed to have an outer shape that is circular in a section perpendicular to the longitudinal direction; and that, when an imaginary line passing through a center of the outer shape and extending in the longitudinal direction of the pin body is defined as a center axis of the pin body; in a region in the longitudinal direction of the pin body where the one-end-side first rounded part is formed, a direction of a fiber flow of the metallic material changes from a direction along the longitudinal direction of the pin body to be closer to the center axis of the pin body, from the side of the one-end-side large diameter part toward the side of the one-end-side second rounded part; in a region in the longitudinal direction of the pin body where the one-end-side second rounded part is formed, the direction of the fiber flow changes to be closer to the direction along the longitudinal direction of the pin body, from the side of the one-end-side first rounded part toward the side of the central small diameter part; in a region in the longitudinal direction of the pin body where the another-end-side first rounded part is formed, a direction of a fiber flow of the metallic material changes from a direction along the longitudinal direction of the pin body to be closer to the center axis of the pin body, from the side of the another-end-side large diameter part toward the side of the another-end-side second rounded part; and in a region in the longitudinal direction of the pin body where the another-end-side second rounded part is formed, the direction of the fiber flow changes to be closer to the direction along the longitudinal direction of the pin body, from the side of the another-end-side first rounded part toward the side of the central small diameter part.

In another preferred mode, in any of the modes of the piston pin, the one-end-side first rounded part is formed to have a radius of curvature that is larger than a radius of curvature of the one-end-side second rounded part, and another-end-side first rounded part is formed to have a radius of curvature that is larger than a radius of curvature of the another-end-side second rounded part.

In another preferred mode, in any of the modes of the piston pin, the one-end-side first rounded part has a center of curvature that is positioned away from an edge on the one end side of the piston body toward the another end side, and the another-end-side first rounded part has a center of curvature that is positioned away from an edge of the another end side of the piston body toward the one end side.

In another preferred mode, in any of the modes of the piston pin, in a longitudinal sectional view of the pin body, each of the one-end-side large diameter part and the another-end-side large diameter part has an inner peripheral surface that is substantially parallel with the longitudinal direction of the pin body.

In another preferred mode, in any of the modes of the piston pin, the piston of the internal combustion engine comprises a pair of pin holes into which the piston pin is inserted, the pair of pin holes is formed at a pair of end parts on a center side in the longitudinal direction of the pin body with one-end-side roller burnished part and another-end-side roller burnished part as regions subjected to a roller burnishing treatment respectively, a whole region of the one-end-side second rounded part is positioned on the one end side in the longitudinal direction of the pin body relative to a whole region of the one-end-side roller burnished part, and a whole region of the another-end-side second rounded part is positioned on the another end side in the longitudinal direction of the pin body relative to a whole region of the another-end-side roller burnished part.

The piston pin manufacturing method in its mode is a method for manufacturing a piston pin that is equipped with a pin body and a lightening hole formed in a longitudinal direction of the pin body, the piston pin connecting a piston and a connecting rod of an internal combustion engine, the lightening hole comprising one-end-side large diameter part provided at one end side in the longitudinal direction of the pin body; another-end-side large diameter part provided at another end side in the longitudinal direction of the pin body; a central small diameter part that is provided between the one-end-side large diameter part and the another-end-side large diameter part, the central small diameter part having an inner diameter smaller than those of the one-end-side large diameter part and the another-end-side large diameter part; one-end-side first rounded part that is provided between the one-end-side large diameter part and the central small diameter part, the one-end-side first rounded part having an inner diameter that decreases from a side of the one-end-side large diameter part toward a side of the central small diameter part, the one-end-side first rounded part having a rate of change of the inner diameter that increases from the side of the one-end-side large diameter part toward the side of the central small diameter part; one-end-side second rounded part that is provided between the one-end-side first rounded part and the central small diameter part, the one-end-side second rounded part having an inner diameter that decreases from the one-end-side first rounded part toward the side of the central small diameter part, the one-end-side second rounded part having a rate of change of the inner diameter that decreases from the side of the one-end-side first rounded part toward the side of the central small diameter part; another-end-side first rounded part that is provided between the another-end-side large diameter part and the central small diameter part, the another-end-side first rounded part having an inner diameter that decreases from a side of the another-end-side large diameter part toward a side of the central small diameter part, the another-end-side first rounded part having a rate of change of the inner diameter that increases from the side of the another-end-side large diameter part toward the side of the central small diameter part; and another-end-side second rounded part that is provided between the another-end-side first rounded part and the central small diameter part, the another-end-side second rounded part having an inner diameter that decreases from the another-end-side first rounded part toward the side of the central small diameter part, the another-end-side second rounded part having a rate of change of the inner diameter that decreases from the side of the another-end-side first rounded part toward the side of the central small diameter part. It comprises the steps of pressing a die conforming to a shape of the lightening hole against a metallic workpiece that forms the pin body, from the one end side in the longitudinal direction of the pin body, to achieve a plastic deformation; and pressing a die conforming to a shape of the lightening hole against the metallic workpiece from the another end side in the longitudinal direction of the pin body, to achieve a plastic deformation.

In a preferred mode of the piston manufacturing method, in a longitudinal sectional view of the pin body, each of the one-end-side large diameter part and the another-end-side large diameter part has an inner peripheral surface that is substantially parallel with the longitudinal direction of the pin body.

In another preferred mode, in any of the modes of the piston manufacturing method, the one-end-side first rounded part is formed to have a radius of curvature that is larger than a radius of curvature of the one-end-side second rounded part, and the another-end-side first rounded part is formed to have a radius of curvature that is larger than a radius of curvature of the another-end-side second rounded part.

In another preferred mode, in any of the modes of the piston manufacturing method, the one-end-side first rounded part has a center of curvature that is positioned away from an edge on the one end side of the piston body toward the another end side, and the another-end-side first rounded part has a center of curvature that is positioned away from an edge of the another end side of the piston body toward the one end side.

In another preferred mode, in any of the modes of the piston manufacturing method, the piston of the internal combustion engine comprises a pair of pin holes into which the piston pin is inserted, the pair of pin holes is formed at a pair of end parts on a center side in the longitudinal direction of the pin body with one-end-side roller burnished part and another-end-side roller burnished part as regions subjected to a roller burnishing treatment respectively, a whole region of the one-end-side second rounded part is positioned on the one end side in the longitudinal direction of the pin body relative to a whole region of the one-end-side roller burnished part, and a whole region of the another-end-side second rounded part is positioned on the another end side in the longitudinal direction of the pin body relative to a whole region of the another-end-side roller burnished part.

1. A piston pin that is equipped with a pin body made of a metallic material and a lightening hole formed in a longitudinal direction of the pin body, the piston pin connecting a piston and a connecting rod of an internal combustion engine, the lightening hole comprising:
one-end-side large diameter part provided at one end side in the longitudinal direction of the pin body;
another-end-side large diameter part provided at another end side in the longitudinal direction of the pin body;
a central small diameter part that is provided between the one-end-side large diameter part and the another-end-side large diameter part, the central small diameter part having an inner diameter smaller than those of the one-end-side large diameter part and the another-end-side large diameter part;
one-end-side first rounded part that is provided between the one-end-side large diameter part and the central small diameter part, the one-end-side first rounded part having an inner diameter that decreases from a side of the one-end-side large diameter part toward a side of the central small diameter part, the one-end-side first rounded part having a rate of change of the inner diameter that increases from the side of the one-end-side large diameter part toward the side of the central small diameter part;
one-end-side second rounded part that is provided between the one-end-side first rounded part and the central small diameter part, the one-end-side second rounded part having an inner diameter that decreases from the one-end-side first rounded part toward the side of the central small diameter part, the one-end-side second rounded part having a rate of change of the inner diameter that decreases from the side of the one-end-side first rounded part toward the side of the central small diameter part;
another-end-side first rounded part that is provided between the another-end-side large diameter part and the central small diameter part, the another-end-side first rounded part having an inner diameter that decreases from a side of the another-end-side large diameter part toward the side of the central small diameter part, the another-end-side first rounded part having a rate of change of the inner diameter that increases from the side of the another-end-side large diameter part toward the side of the central small diameter part; and
another-end-side second rounded part that is provided between the another-end-side first rounded part and the central small diameter part, the another-end-side second rounded part having an inner diameter that decreases from the another-end-side first rounded part toward the side of the central small diameter part, the another-end-side second rounded part having a rate of change of the inner diameter that decreases from the side of the another-end-side first rounded part toward the side of the central small diameter part.

2. The piston pin as claimed in claim 1, wherein the pin body is shaped by forging and is formed to have an outer shape that is circular in a section perpendicular to the longitudinal direction; and
wherein, when an imaginary line passing through a center of the outer shape and extending in the longitudinal direction of the pin body is defined as a center axis of the pin body,
in a region in the longitudinal direction of the pin body where the one-end-side first rounded part is formed, a direction of a fiber flow of the metallic material changes from a direction along the longitudinal direction of the pin body to be closer to the center axis of the pin body, from the side of the one-end-side large diameter part toward the side of the one-end-side second rounded part,
in a region in the longitudinal direction of the pin body where the one-end-side second rounded part is formed, the direction of the fiber flow changes to be closer to the direction along the longitudinal direction of the pin body, from the side of the one-end-side first rounded part toward the side of the central small diameter part,
in a region in the longitudinal direction of the pin body where the another-end-side first rounded part is formed, a direction of a fiber flow of the metallic material changes from a direction along the longitudinal direction of the pin body to be closer to the center axis of the pin body, from the side of the another-end-side large diameter part toward the side of the another-end-side second rounded part, and
in a region in the longitudinal direction of the pin body where the another-end-side second rounded part is formed, the direction of the fiber flow changes to be closer to the direction along the longitudinal direction of the pin body, from the side of the another-end-side first rounded part toward the side of the central small diameter part.

3. The piston pin as claimed in claim 2, wherein the one-end-side first rounded part is formed to have a radius of curvature that is larger than a radius of curvature of the one-end-side second rounded part, and
wherein the another-end-side first rounded part is formed to have a radius of curvature that is larger than a radius of curvature of the another-end-side second rounded part.

4. The piston pin as claimed in claim 2, wherein the one-end-side first rounded part has a center of curvature that is positioned away from an edge on the one end side of the piston body toward the another end side, and
wherein the another-end-side first rounded part has a center of curvature that is positioned away from an edge of the another end side of the piston body toward the one end side.

5. The piston pin as claimed in claim 1, wherein, in a longitudinal sectional view of the pin body, each of the one-end-side large diameter part and the another-end-side large diameter part has an inner peripheral surface that is substantially parallel with the longitudinal direction of the pin body.

6. The piston pin as claimed in claim 1, wherein the piston of the internal combustion engine comprises a pair of pin holes into which the piston pin is inserted,
wherein the pair of pin holes is formed at a pair of end parts on a center side in the longitudinal direction of the pin body with one-end-side roller burnished part and another-end-side roller burnished part as regions subjected to a roller burnishing treatment, respectively,
wherein a whole region of the one-end-side second rounded part is positioned on the one end side in the longitudinal direction of the pin body relative to a whole region of the one-end-side roller burnished part, and
wherein a whole region of the another-end-side second rounded part is positioned on the another end side in the longitudinal direction of the pin body relative to a whole region of the another-end-side roller burnished part.

7. A method for manufacturing a piston pin that is equipped with a pin body and a lightening hole formed in a longitudinal direction of the pin body, the piston pin connecting a piston and a connecting rod of an internal combustion engine, the lightening hole comprising:
one-end-side large diameter part provided at one end side in the longitudinal direction of the pin body;
another-end-side large diameter part provided at another end side in the longitudinal direction of the pin body;
a central small diameter part that is provided between the one-end-side large diameter part and the another-end-side large diameter part, the central small diameter part having an inner diameter smaller than those of the one-end-side large diameter part and the another-end-side large diameter part;
one-end-side first rounded part that is provided between the one-end-side large diameter part and the central small diameter part, the one-end-side first rounded part having an inner diameter that decreases from a side of the one-end-side large diameter part toward a side of the central small diameter part, the one-end-side first rounded part having a rate of change of the inner diameter that increases from the side of the one-end-side large diameter part toward the side of the central small diameter part;
one-end-side second rounded part that is provided between the one-end-side first rounded part and the central small diameter part, the one-end-side second rounded part having an inner diameter that decreases from the one-end-side first rounded part toward the side of the central small diameter part, the one-end-side second rounded part having a rate of change of the inner diameter that decreases from the side of the one-end-side first rounded part toward the side of the central small diameter part;
another-end-side first rounded part that is provided between the another-end-side large diameter part and the central small diameter part, the another-end-side first rounded part having an inner diameter that decreases from a side of the another-end-side large diameter part toward a side of the central small diameter part, the another-end-side first rounded part having a rate of change of the inner diameter that increases from the side of the another-end-side large diameter part toward the side of the central small diameter part; and
another-end-side second rounded part that is provided between the another-end-side first rounded part and the central small diameter part, the another-end-side second rounded part having an inner diameter that decreases from the another-end-side first rounded part toward the side of the central small diameter part, the another-end-side second rounded part having a rate of change of the inner diameter that decreases from the side of the another-end-side first rounded part toward the side of the central small diameter part, the method comprising the steps of:
pressing a die conforming to a shape of the lightening hole against a metallic workpiece that forms the pin body, from the one end side in the longitudinal direction of the pin body, to achieve a plastic deformation; and
pressing a die conforming to a shape of the lightening hole against the metallic workpiece from the another end side in the longitudinal direction of the pin body, to achieve a plastic deformation.

8. The piston pin manufacturing method as claimed in claim 7, wherein, in a longitudinal sectional view of the pin body, each of the one-end-side large diameter part and the another-end-side large diameter part has an inner peripheral surface that is substantially parallel with the longitudinal direction of the pin body.

9. The piston pin manufacturing method as claimed in claim 7, wherein the one-end-side first rounded part is formed to have a radius of curvature that is larger than a radius of curvature of the one-end-side second rounded part, and
wherein the another-end-side first rounded part is formed to have a radius of curvature that is larger than a radius of curvature of the another-end-side second rounded part.

10. The piston pin manufacturing method as claimed in claim 7, wherein the one-end-side first rounded part has a center of curvature that is positioned away from an edge on the one end side of the piston body toward the another end side, and
wherein the another-end-side first rounded part has a center of curvature that is positioned away from an edge of the another end side of the piston body toward the one end side.

11. The piston pin manufacturing method as claimed in claim 7, wherein the piston of the internal combustion engine comprises a pair of pin holes into which the piston pin is inserted,
wherein the pair of pin holes is formed at a pair of end parts on a center side in the longitudinal direction of the pin body with one-end-side roller burnished part and another-end-side roller burnished part as regions subjected to a roller burnishing treatment, respectively,
wherein a whole region of the one-end-side second rounded part is positioned on the one end side in the longitudinal direction of the pin body relative to a whole region of the one-end-side roller burnished part, and
wherein a whole region of the another-end-side second rounded part is positioned on the another end side in the longitudinal direction of the pin body relative to a whole region of the another-end-side roller burnished part.
